(19) United States
(12) Patent Application Publication
(10) Pub. No.: US 2006/0134995 A1
(43) Pub. Date: Jun. 22, 2006

(54) Systems and methods for reducing crosstalk between communications connectors

(76) Inventors: Masud Bolouri-Saransar, Orland Park, IL (US); Andrew Ciezak, Mokena, IL (US); Ronald A. Nordin, Naperville, IL (US)

Correspondence Address: PANDUIT CORP., LEGAL DEPARTMENT - TP12, 17301 SOUTH RIDGELAND AVENUE, TINLEY PARK, IL, 60477, US

(21) Appl. No.: 11/301,921

(22) Filed: Dec. 13, 2005

Related U.S. Application Data
(60) Provisional application No. 60/637,025, filed on Dec. 17, 2004.

(51) Int. Cl. H01R 24/00

(52) U.S. Cl. 439/676

(57) ABSTRACT

Communications connectors are provided with conductive covering layers to reduce the amount of alien near-end crosstalk (ANEXT) between connectors at IDC terminals when they are installed alongside one another.

### CROSS-REFERENCE TO RELATED APPLICATION

This application claims the benefit of U.S. Provisional Application No. 60/637,025, filed Dec. 17, 2004 and entitled “Systems and Methods for Reducing Crosstalk Between Communications Connectors.”

### FIELD OF THE INVENTION

The present invention is generally directed to communications connectors and more specifically directed to systems and methods for reducing crosstalk between communications connectors.

### BACKGROUND OF THE INVENTION

In communications systems, alien near-end crosstalk, or ANEXT, in a component is the coupling of crosstalk noise at the near end from a differential pair external to the component into a victim differential pair within the component. ANEXT effects can be reduced to an acceptable level by suppression of the external perturbation. Compensation techniques may also be used to reduce ANEXT effects.

A compensation technique that can reduce ANEXT to an acceptable level requires that both sides of the differential pair be equally (or close to equally) coupled to the external perturbation.

As frequencies and data rates rise in communications systems, ANEXT between neighboring connector components contributes to overall ANEXT within a communications channel. There is a desire to reduce ANEXT in communications channels in order to maintain high-quality communications.

### SUMMARY OF THE INVENTION

Improved systems and methods are provided to reduce ANEXT between communications connectors at IDC terminals.

According to one embodiment of the present invention, a communications jack is provided with a conductive layer to reduce ANEXT between adjacent connectors.

Conductive layers according to the present invention may be foil coverings, conductive printing, conductive paint, plating of selected parts of a communications jack, impregnation of component parts with conductive materials, or combinations of these coverings.

In one embodiment, plastic parts of a communication jack are impregnated with absorber material.

Conductive coverings may be provided on multiple sides of a communications jack. In one embodiment, conductive coverings are provided on three sides of a communications jack. In another embodiment, conductive coverings are provided on four sides of a communications jack.

According to some embodiments of the present invention, coupling occurs between insulation displacement contacts (IDCs) of jacks and the conductive coverings of the jacks, and coupling further occurs between the conductive coverings of adjacent jacks. This results in compensation of the ANEXT, decreasing ANEXT between the two jacks.

### BRIEF DESCRIPTION OF THE DRAWINGS

FIG. 1 is a front upper perspective view of a communications jack according to one embodiment of the present invention with a conductive foil being wrapped around three sides of the jack;

FIG. 2 is a front upper perspective view of a the communications jack of FIG. 1;

FIG. 3 is a front lower perspective view of the communications jack of FIG. 1;

FIG. 4 is a plan view of the conductive foil of FIGS. 1-3;

FIG. 5 is a rear lower perspective view of a communications jack according to one embodiment of the present invention;

FIG. 6 is a rear upper perspective view of the communications jack of FIG. 5; and

FIG. 7 is a diagram showing the interactions that occur in communications jacks according to one embodiment of the present invention.

### DETAILED DESCRIPTION OF THE ILLUSTRATED EMBODIMENTS

Communications connectors such as electrical jacks are often installed adjacent one another, for example in communications patch panels and switches. As the frequency and data rate of communications signals increase, crosstalk increases between elements of adjacent communications jacks.

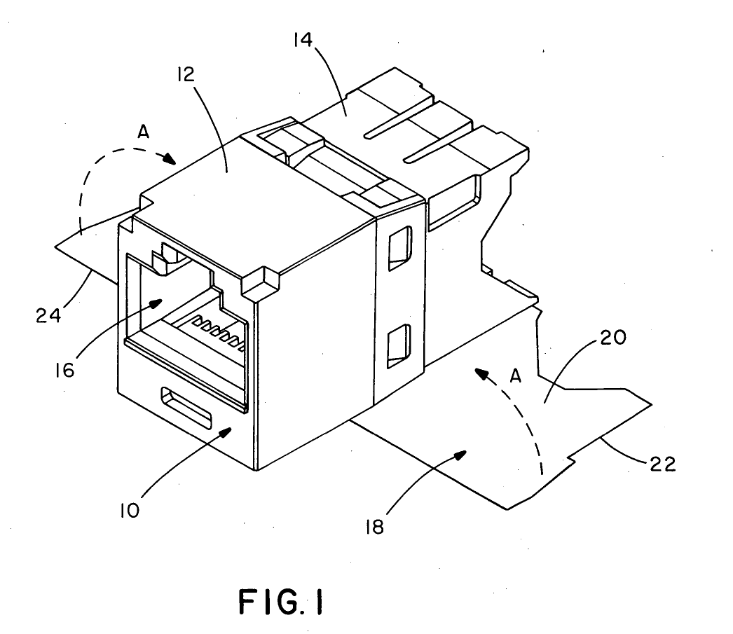

FIG. 1 shows a communications jack 10 adapted to reduce the crosstalk that occurs when two communications jacks 10 are installed adjacent one another. The communications jack 10 comprises a jack housing 12 and a rear sled 14. The jack housing has a plug-receiving aperture 16.

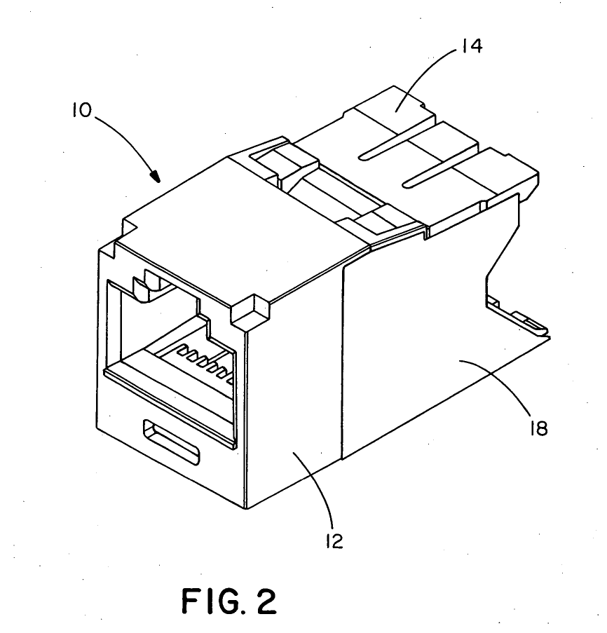

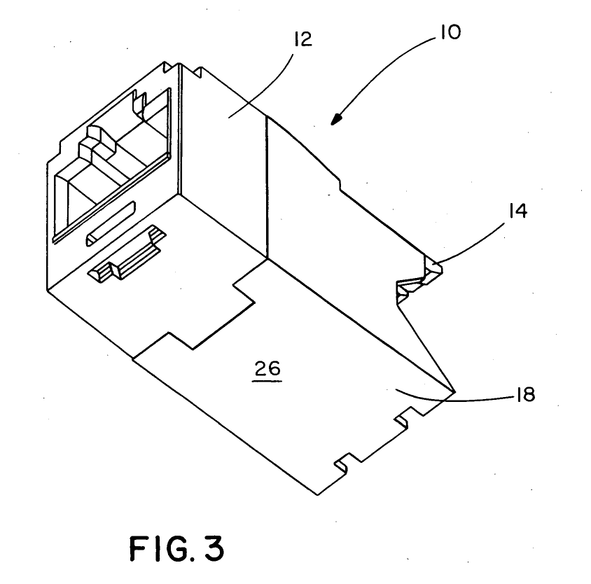

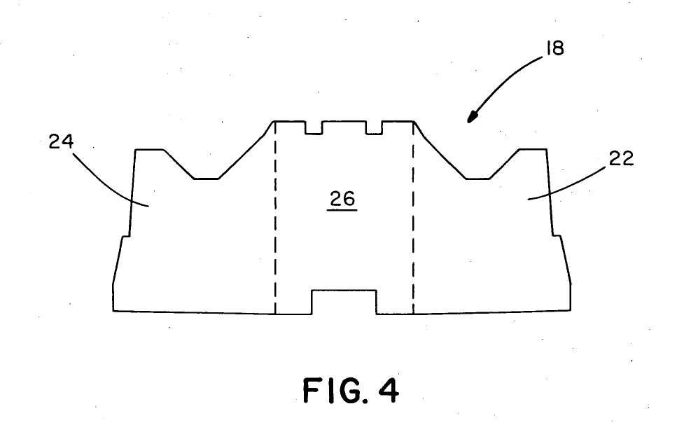

In the embodiment of FIG. 1, a foil covering 18 is provided for wrapping around three sides of the jack 10. FIG. 2 shows the jack 10 after first and second flaps 22 and 24 of the foil covering have been folded upwardly as shown by the arrows “A” of FIG. 1. The foil covering 18 has an adhesive surface 20 that adheres to outer surfaces of the jack 10. As shown in FIG. 2, the foil covering 18 covers the sides of the rear sled 14 almost completely, and partially overlaps the sides of the jack housing 12. FIG. 3 shows a lower perspective view of the plug 10, in which a central portion 26 of the foil covering 18 covers the bottom surface of the rear sled 14 and overlaps a portion of the bottom surface of the jack housing 12. FIG. 4 is a plan view of the foil covering 18 of FIGS. 1-3, showing the central portion 26 and the first and second flaps 22 and 24. The foil covering enables compensating coupling between adjacent communications jacks, reducing ANEXT between the jacks.

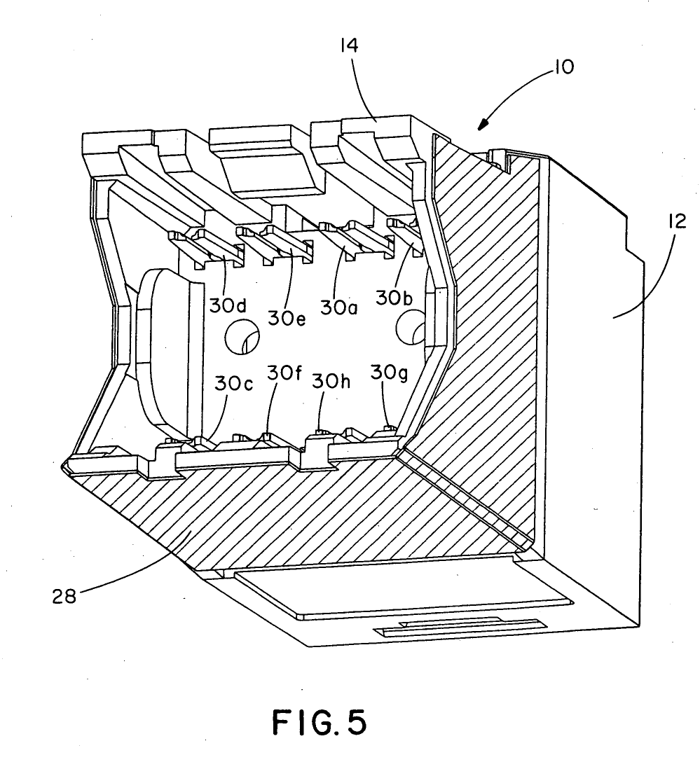

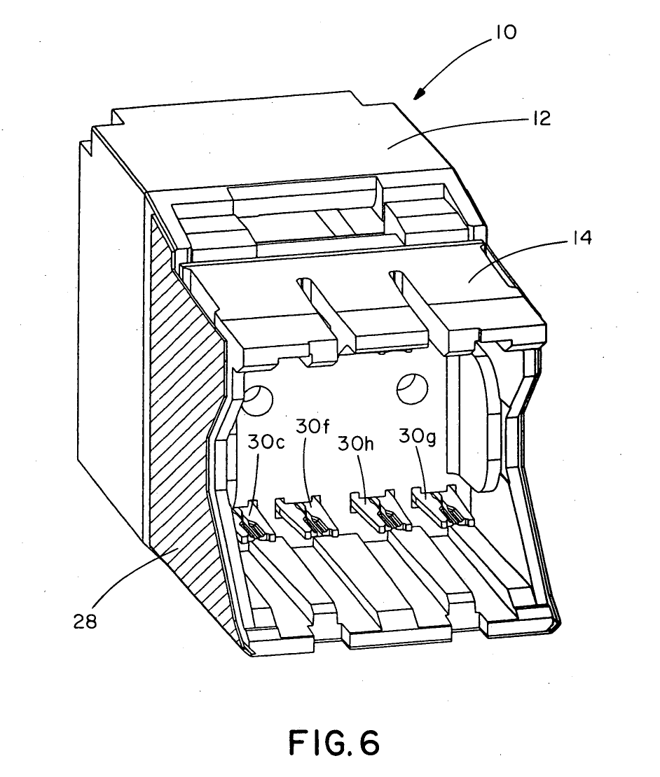

Turning now to FIG. 5, a rear lower perspective view of a communications jack 10 with a conductive layer 28 is shown. In the embodiment of FIG. 5, the conductive layer 28 is a foil covering similar to the foil covering 18 of FIGS. 1-4. IDCs 30a-30h contact wires of a communication cable (not shown). According to one embodiment for use with a four-pair communications cable, the IDCs 30a-30h correspond, respectively, to first through eighth conductors of the cable. This arrangement of IDCs is an example of one embodiment of the present invention; in other embodiments, the IDCs may be provided in different arrangements. FIG. 6 is a rear upper perspective view of the communications jack 10 with the conductive layer 28.

Conductive layers according to the present invention result in the reduction of inductive coupling and both reduction and compensation in capacitive coupling to reduce ANEXT between adjacent jacks. One type of conductive layer is a foil covering, as shown in FIGS. 1-6. Other types of conductive layers may be utilized with the present invention, including a printed conductive layer, conductive paint, plating of selected component parts, or impregnation of component parts with conductive materials. In addition, suppression of coupling between adjacent communications connectors can be achieved by wrapping or coating components with RF absorber material, or by impregnating plastic parts of the connectors with absorber material.

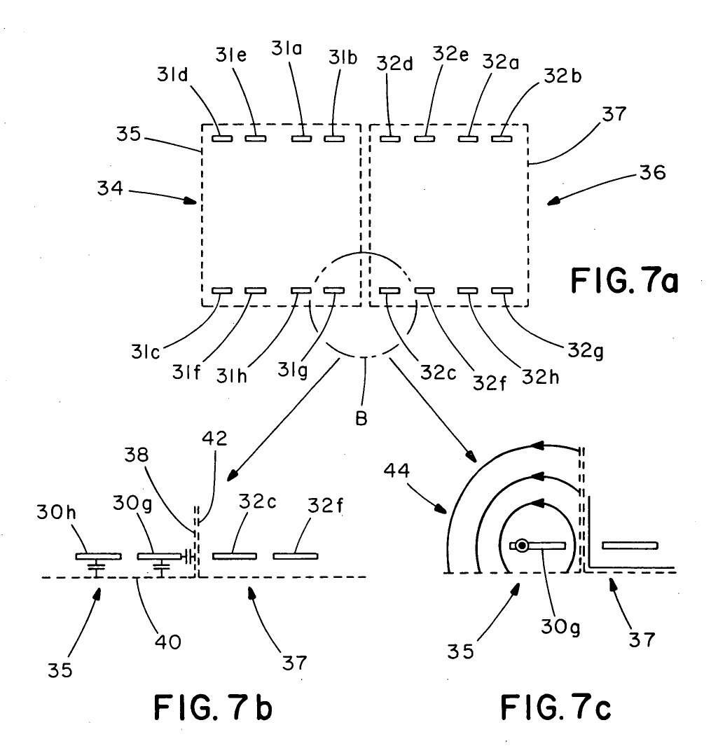

FIGS. 7a, 7b, and 7c illustrate the interaction between IDCs and conductive coverings of adjacent communication jacks according to one embodiment of the present invention. FIG. 7a is a simplified diagram showing the IDCs 31a-31h of a first jack 34 surrounded by a first conductive layer 35 and the IDCs 32a-32h of a second jack 36 surrounded by a second conductive layer 37. For the purposes of this illustration, the first pair of IDCs 30g and 30h may be considered the “source pair,” and the second pair of IDCs 32c and 32f may be considered the “sink pair.” FIG. 7b, a detail view of the circle “B” of FIG. 7a, shows the capacitive coupling that occurs between the IDCs 30g and 30h and the first conductive layer 35. A nearly equal amount of capacitive coupling occurs between each of the source IDCs 30g and 30h and the conductive layer 35. Slightly more capacitive coupling occurs between the source IDC 30g and the first conductive layer 35, because the edge of the source IDC 30g is nearer the vertical portion 38 of the first conductive layer 35 than is the edge of the IDC 30h. Because the source IDCs 30g and 30h conduct differential-mode signals that are 180° out of phase with one another, their capacitive couplings to the horizontal portion 40 of the first conductive layer 35 will effectively cancel each other out.

The small amount of coupling remaining between the source IDC 30g and the vertical portion 38 of the first conductive layer 35 will be capacitively coupled to the vertical portion 42 of the second conductive layer 37. This noise, in turn, will be capacitively coupled to the sink pair of IDCs 32c and 32f, with substantially equal coupling occurring between the second conductive layer 37c and the sink pair of IDCs 32c and 32f. Again, slightly more coupling will occur between the second conductive layer 37 and the sink IDC 32c. Because the capacitively-coupled noise is very nearly common mode noise, and further because the sink pair of IDCs 32c and 32f operates in the differential mode, the effect of the coupled noise on the signals of the sink pair is minimized. In the embodiments shown and described, the conductive layers are not terminated to ground or to cable shielding or screening.

As shown in FIG. 7c, inductive coupling between the IDCs of adjacent jacks having conductive layers is prevented. For example, the magnetic field lines 44 resulting from the current flowing through the IDC 30g do not penetrate the conductive layer 35. FIGS. 7a-7c show four-sided conductive layers on the jacks, but similar couplings occur with three-sided conductive layers as shown in FIGS. 1-6.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A communications connector arrangement comprising:
a first connector having a plug-receiving aperture, a first pair of insulation-displacement contacts, and a first conductive layer on an outside surface of said first connector, said first conductive layer being disposed in a region adjacent said plurality of insulation-displacement contacts; and
a second connector adjacent to said first connector and having a plug-receiving aperture, a second pair of insulation-displacement contacts, and a second conductive layer on an outside surface of said second connector, said second conductive layer being disposed in a region adjacent said second plurality of insulation-displacement contacts;
wherein each of said first pair of insulation displacement contacts is capacitively coupled to said first conductive layer, each of said second pair of insulation displacement contacts is capacitively coupled to said second conductive layer, and said first conductive layer is capacitively coupled to said second conductive layer.

2. The communications connector arrangement of claim 1 wherein at least one of said first conductive layer and said second conductive layer comprises an adhesive-backed foil covering.

3. The communications connector arrangement of claim 1 wherein at least one of said first conductive layer and said second conductive layer is selected from the group consisting of a printed conductive layer, a conductive paint layer, a plated layer, and a conductor-impregnated layer.

4. The communications connector arrangement of claim 1 wherein said first and second conductive layers reduce inductive coupling between said first pair of insulation displacement contacts and said second pair of insulation displacement contacts.

5. The communications connector arrangement of claim 1 wherein said first connector comprises a top, a bottom, and left and right sides, said first conductive layer is disposed along said bottom, left, and right sides, and first and second insulation displacement contacts of said first pair of insulation displacement contacts are approximately equidistant from said bottom side.

6. The communications connector of claim 5 wherein said second insulation displacement contact is closer to said right side than said first insulation displacement contact is.

7. The communications connector arrangement of claim 1 wherein neither said first conductive layer nor said second conductive layer is terminated to ground or to a cable screen.

8. A communications connector having top, bottom, left, and right sides and comprising:
a jack housing having a plug-receiving aperture therein;
a rear sled;
at least one pair of insulation displacement contacts disposed within said rear sled; and
a conductive covering disposed along and attached to an outer surface of said rear sled adjacent to the location of said pair of insulation displacement contacts, said conductive covering being attached to said bottom, left, and right sides of said communications connector.

9. The communications connector of claim 8 wherein said conductive covering comprises a foil covering that is adhesively attached to said outer surface of said rear sled.

10. The communications connector of claim 9 wherein said conductive covering is further disposed along and attached to a portion of said jack housing.

11. The communications connector of claim 8 wherein said conductive covering is further disposed along and attached to said top side of said communications connector.

12. The communications connector of claim 8 wherein said conductive covering is not terminated to ground or to a cable screen.
